(19) United States
(12) Patent Application Publication
(10) Pub. No.: US 2012/0185579 A1
(43) Pub. Date: Jul. 19, 2012

(54) RACK-MOUNTED POSITION MANAGEMENT SYSTEM FOR ELECTRONIC DEVICES

(75) Inventor: Takafumi Watanabe, Tokyo (JP)

(73) Assignee: NEC Corporation, Tokyo (JP)

(21) Appl. No.: 13/347,842

(22) Filed: Jan. 11, 2012

(30) Foreign Application Priority Data
Jan. 14, 2011 (JP) P2011-005594

(51) Int. Cl. G06F 15/173

(52) U.S. Cl. 709/223

(57) ABSTRACT

A rack-mounted position management system is automatically implemented by an administrative station adapted to a rack, which is equipped with a plurality of transmitters for transmitting positional information in connection with a plurality of mounted positions for mounting a plurality of electronic devices (e.g. servers). The positional information includes coordinate information representing the setup position of the rack and secondary coordinate information representing the mounted position of the electronic device. The administrative station is connected to the electronic devices over a network. The administrative station sends a request signal to the electronic device, which in turn sends back the positional information to the administrative station. Thus, the administrative station is able to determine the mounted positions of the electronic devices independently.

### BACKGROUND OF THE INVENTION

1. Field of the Invention

The present invention relates to a rack-mounted position management system that manages positions of electronic devices such as servers installed in racks.

The present application claims priority on Japanese Patent Application No. 2011-5594, the content of which is incorporated herein by reference.

2. Description of the Related Art

Generally speaking, facilities holding numerous servers need an efficient management of servers. Recently, data centers have increased in scale due to expanding services of cloud computing, so that an efficient management of servers is an important factor for data centers. For instance, a server management method can be implemented to identify and manage servers by use of network addresses (e.g. addresses of servers connected to communication networks) such as IP (Internet Protocol) addresses. This server management method using network addresses may effectively work in identifying and managing servers on networks. Herein, a server management device is used to access servers according to their network addresses and receive various pieces of information representing load conditions which are detected by servers executing their management functions. This server management device allows an administrator to monitor conditions of servers collectively.

In order to carry out manual operation such as maintenance of servers, it is necessary for an administrator or operator to recognize positional information of servers in addition to network addresses. Network addresses can be determined irrespectively of physical positions of servers and therefore do not precisely indicate physical positions of servers. For this reason, it is difficult for an administrator or operator to identify servers subject to manual operation by using network addresses alone. Additionally, network addresses may not be devoted to partitioned management of servers whose positions are partitioned into subdivisions. When power is turned off in a rack storing servers for the purpose of manual operation, it is difficult for an administrator or operator to grasp and manage servers affected by a power-off event by use of network addresses alone.

To cope with this drawback, it is necessary to prepare a mounted position list describing the relationship between network addresses and mounted positions of servers in advance. Herein, network addresses of servers subject to manual operation are used as keys to search through the mounted position list so as to retrieve mounted positions of servers. However, it is laborious for an implementor to manually create a mounted position list every time servers are newly installed in racks. In particular, large-scale data centers holding numerous servers need a long time for an implementor to create mounted position lists; this causes a high load on an implementor creating mounted position lists. Instead of an implementor being designated for creation of mounted position lists, a server installer can be designated to create mounted position lists. In this case, the server installer may be overburdened in creating mounted position lists and thus increase his/her working hours in installing servers. Additionally, the server installer may be further assigned an additional load of updating mounted position lists when installing new servers in racks or removing servers from racks. If the server installer neglects to update mounted position lists, a maintenance operator cannot specify servers subject to maintenance.

The foregoing technology, in which servers are managed using network addresses so that a mounted position list describing the relationship between network addresses and mounted positions of servers needs to be manually created, suffers from the following problems.

### (1) First Problem

Every time a new server installed in a rack, its mounted position needs to be described in a mounted position list. The foregoing problem does not matter if a relatively small number of servers are installed in racks. However, when numerous servers need to be installed in racks at once, the foregoing technology requires laborious work for an implementor who handles mounted position lists. Similarly, when numerous servers are removed from racks or relocated to other racks, the foregoing technology requires an implementor to conduct laborious work in removing or relocating those servers.

### (2) Second Problem

Management is needed for mounted position lists. To normally secure the latest and precise form of mounted position lists, it is necessary to determine a good policy of managing mounted position lists, which needs long working hours.

### (3) Third Problem

Server management needs to handle inventory taking/clearance. Companies involved in asset inventory taking/clearance need to create lists describing types and mounted positions of devices. Large-scale data centers require laborious work in creating those lists. Additionally, when servers are installed in data centers located outside companies, an implementor who handles mounted position lists needs to bear a high load of working on lists at the sites of outside data centers.

Patent Document 1 discloses a configuration management system that automatically detects and manages mounted positions of servers installed in racks. This configuration management system adopts a rack furnished with a reader for reading information of a tag attached to each server, wherein a controller (or a communication device) of a rack sends the information of each server to an administrative station.

Patent Document 2 discloses a highly integrated server management system that is able to graphically display positional information of servers. However, it fails to disclose details for creating a positional information database describing positional information of servers.

In the configuration management system of Patent Document 1, an administrative station confirms rack information representing a rack holding servers on tiers, and then it confirms positions of servers mounted on tiers. The rack information indicates the name, type, and production number of a rack as well as its size representing the number of servers mountable in a rack.

If the configuration management system of Patent Document 1 is modified to incorporate positional information of a rack into the rack information, for example, the administrative station is able to manage the position of a rack as well as positions of servers installed in rack. However, even the modified configuration management system suffers from the following drawbacks due to its operation in which the reader of a rack reads information of a tag attached to each server, and then the controller (or the communication device) of a rack sends the read information to the administrative station.

In the configuration management system, servers are unable to confirm their mounted positions by way of communication with the controller of a rack because of fixed communicating functions in which servers acting as the transmission side cannot receive information from a rack acting as the reception side, so that the administrative station needs to carry out tied processing on the mounted positions of servers. The tied processing is implemented by the administrative station with reference to a table describing the relationship between server IDs and IP addresses. Herein, the administrative station uses a server ID read from an electronic tag of each server as a key to search through the table so as to read the positional information of each server. The time needed for implementation of the tied processing becomes longer as the number of servers installed in a rack becomes larger.

The administrative station needs to implement management software specifically designed to collect positional information by way of communication with the controller of a rack. In other words, commercially available personal computers which do not install specific management software are unable to manage servers with reference to positional information.

The configuration management system needs a communication device, attached to a rack, specifically designed to receive information from servers and send information to the administrative station, and a communication line connected between the administrative station and the communication device of a rack.

### PRIOR ART DOCUMENTS

Patent Document Japanese Patent Application Publication No. 2007-226582
Patent Document 2: Japanese Patent Application Publication No. 2003-288236

### SUMMARY OF THE INVENTION

It is an object of the present invention to provide a rack-mounted position management system that is able to manage servers installed in racks without causing the foregoing problems and drawbacks.

A first aspect of the present invention refers to a rack-mounted position management system. The rack-mounted position management system includes a rack (e.g. a server rack) equipped with a plurality of transmitters (e.g. radio communication modules) for transmitting positional information in connection with a plurality of mounted positions; a plurality of electronic devices (e.g. servers) mounted on the plurality of mounted positions inside the rack; and an administrative station that manages the mounted positions of the electronic devices inside the rack. The electronic devices are equipped with their receivers (e.g. radio communication modules), which are positioned opposite to the transmitters, and their communication devices connectible to a network. The administrative station is equipped with a communication device connectible to the network. Upon receiving a request signal from the administrative station, the communication device of the electronic device sends the positional information, which is received by the receiver of the electronic device, to the administrative station, so that the administrative station determines the mounted position of the electronic device.

In this connection, the positional information includes coordinate information representing a setup position of the rack and secondary coordinate information representing each of the mounted positions for mounting the electronic devices inside the rack.

A second aspect of the present invention refers to a rack which includes a plurality of mounted positions for mounting a plurality of electronic devices, and a plurality of transmitters for transmitting positional information in connection with the plurality of mounted positions.

A third aspect of the present invention refers to an electronic device which includes a receiver that receives positional information inside a rack, and a communication device that sends the positional information over a network.

A fourth aspect of the present invention refers to a rack-mounted position management method adapted to the rack-mounted position management system that manages a plurality of electronic devices installed in a rack under control of an administrative station. The rack-mounted position management method includes the steps of: receiving, by the electronic device, positional information transmitted by a transmitter of the rack; upon receiving a request signal from the administrative station, sending the positional information from the electronic device to the administrative station; and determining, by the administrative station, the mounted position of the electronic device inside the rack.

Since the electronic device is equipped with its receiver for receiving positional information, indicating the mounted position thereof inside the rack, transmitted by the transmitter of the rack, it is possible to automatically set the positional information to the electronic device which is mounted on its position inside the rack. Thus, the present invention is able to automatically set and manage the mounted positions of the electronic devices inside the rack.

### BRIEF DESCRIPTION OF THE DRAWINGS

These and other objects, aspects, and embodiments of the present invention will be described in more detail with reference to the following drawings.

FIG. 1 is a block diagram illustrating a rack-mounted position management system according to a preferred embodiment of the present invention.

FIG. 2 is a flowchart illustrating a procedure for receiving server-rack coordinate information and sending server coordinate information in connection with a server rack included in the rack-mounted position management system.

FIG. 3 flowchart illustrating a procedure acquiring coordinate information with a server.

FIG. 4 is a sequence diagram illustrating a procedure for carrying out mutual communication on secondary coordinate information between an administrative station and a server by way of the rack-mounted position management system shown in FIG. 1.

### DESCRIPTION OF THE PREFERRED EMBODIMENT

The present invention will be described in further detail by way of examples with reference to the accompanying drawings.

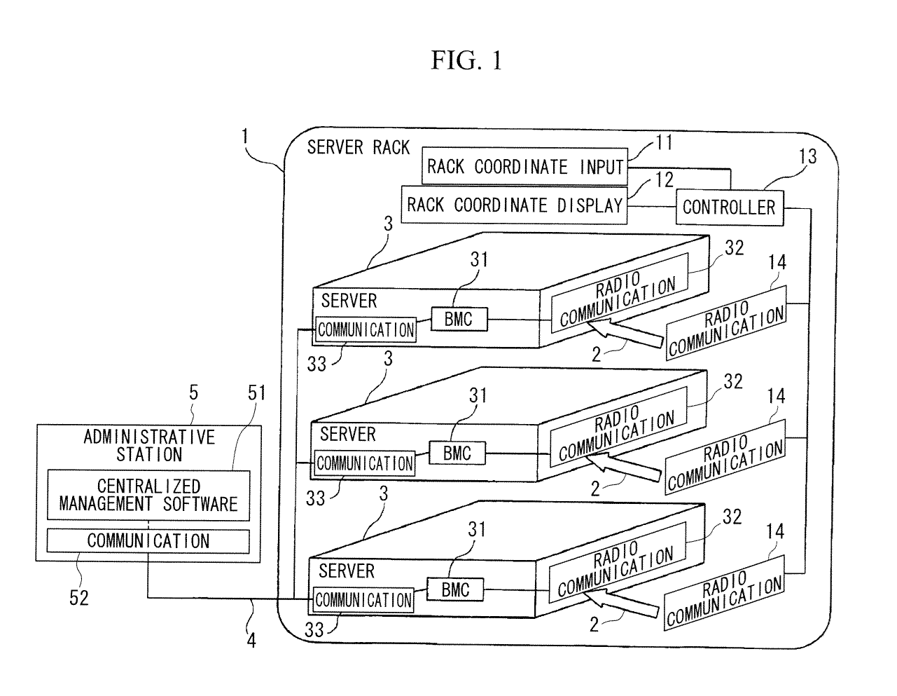

FIG. 1 is a block diagram illustrating a rack-mounted position management system according to a preferred embodiment of the present invention. The rack-mounted position management system includes a server rack 1, servers 3, and an administrative station 5, which are connected via a management network 4. The configuration of the rack-mounted position management system is not necessarily limited to the illustration of FIG. 1; hence, it is possible to combine arbitrary numbers of server racks, servers, and administrative stations. For instance, a plurality of servers 3 can be dispersed among a plurality of server racks. Alternatively, the administrative station 5 can implement distributed processing to manage a plurality of servers 3.

Each server 3 may have the same configuration; or the servers 3 may have different configurations. The management network 4 connecting between the administrative station 5 and the servers 3 may be configured using a specific cable specially adapted to a management network. Alternatively, the management network 4 can be configured using cables combined with other networks.

The server rack 1 includes a rack coordinate input device 11, a rack coordinate display 12, a controller 13, and a plurality of radio communication modules (or transmitters) 14. The rack coordinate input device 11 and the rack coordinate display 12 are connected to the controller 13. The user (e.g. an administrator who manages the servers 3) of the rack-mounted position management system operates the rack coordinate input device 11 to set coordinates of the server rack 1 located in a server room, while the user can confirm the setting content on the rack coordinate display 12. Herein, the “server room” is a room designated to arrange servers. That is, the server rack 1 is set up in a server room, wherein a plurality of servers is installed in the server rack 1. In this connection, the server room does not necessarily refer to a specially designed room for servers but may refer to a machine room in which servers are arranged together with other machines. Additionally, the rack-mounted position management system does not necessarily accommodate to a single server room; hence, the rack-mounted position management system can accommodate to a plurality of server racks located in a plurality of server rooms.

The radio communication modules 14 are connected to the controller 13 and fixed to tiers of the server rack 1 (i.e. mounted positions of the servers 3 in the server rack 1) to communicate with the servers 3. As a communication method adapted to the radio communication modules 14, it is possible to employ various types of noncontact communicating methods. As methods accommodating communication with servers 3, for example, it is possible to employ NFC (Near Field Communication), IrDA (Infrared Data Association), and RFID (Radio Frequency Identification).

Each server 3 includes a BMC (Base Management Controller) 31, a radio communication module (or a receiver) 32, and a communication device 33. The radio communication module 32 is located on the side face of each server 3. When the servers 3 are installed in the server rack 1, the radio communication modules 32 of the servers 3 are positioned opposite to the radio communication modules 14 of the server rack 1 so that they can directly communicate with each other in a face-to-face manner.

The BMC 31 is configured of a CPU (Central Processing Unit) and a memory. That is, the BMC 31 acts as a monitoring device to monitor various hardware elements, remote controls, and recording of events by executing preinstalled programs. The BMC 31 has a function to start the radio communication module 32 and place it in a reception standby mode and a function to transmit information, which the radio communication module 32 receives from the radio communication module 14 of the server rack 1, to the administrative station 5 via the communication device 33.

Specifically, the BMC 31 is connected to the radio communication device 32 and communicates with the controller 13 of the server rack 1 to exchange various pieces of information therebetween by way of the radio communication between the radio communication modules 14 and 32. Additionally, the BMC 31 is connected to the management network 4 via the communication device 33. Since the administrative station 5 is connected to the management network 4 via the communication device 52, the administrative station 5 is able to receive information from the BMC 31 installed in each server 3 via the management network 4.

The administrative station 5 works based on centralized management software 51, thus managing the servers 3 based on information received from the BMCs 31. A CPU of the administrative station 5 reads programs from its own memory so as to implement the centralized management software 51.

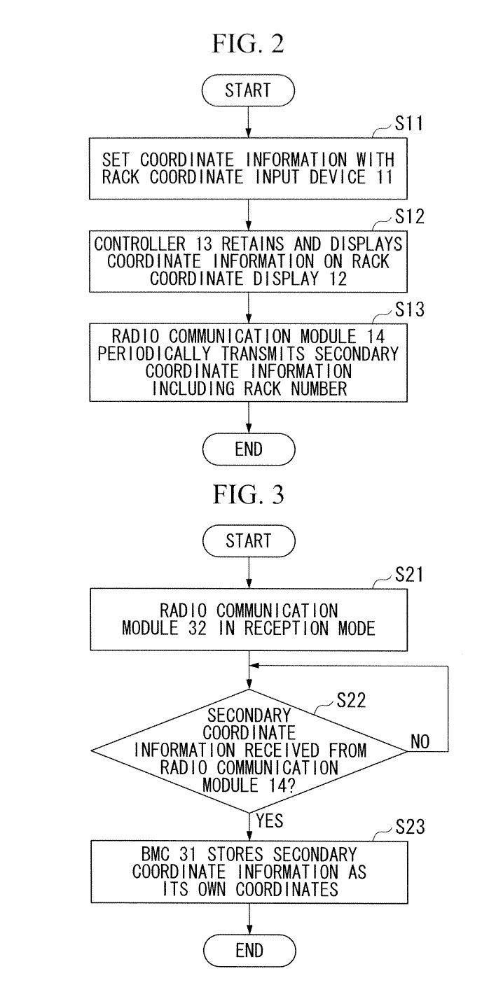

Next, the operation of the rack-mounted position management system of FIG. 1 will be described with reference to FIGS. 2 to 4. The following description refers to the operation of the administrative station 5 which manages a plurality of servers 3 installed in one or more server racks 1 located in a single server room. The administrative station 5 registers one IP address assigned to one server 3 or a plurality of IP addresses assigned to a plurality of servers 3.

FIG. 2 is a flowchart illustrating a procedure for receiving server-rack coordinate information, which is used as the basis for the coordinates of the servers 3, and then sending server coordinate information.

When installing the server rack 1 in a server room, an installer operates the rack coordinate input device 11 to set coordinate information [X,Y] as positional information of the server room (step S11). Herein, a combination of X and Y indicates X-Y two-dimensional coordinates defining the setup position of the server rack 1. As the coordinate information [X,Y], it is possible to employ coordinate data on a schematic drawing such as a floor plan of a server room accommodated for the server rack 1 or terrestrial coordinates consisting of the longitude and latitude. When the administrative station 5 manages a plurality of server racks 1 which are set up in a plurality of server rooms located on different stories of a single building or located in different buildings, for example, the information representing the setup positions of the server racks 1 is not necessarily limited to two-dimensional coordinate information; hence, it is possible to employ information specifying each building accommodated for server rooms, information specifying each story of a building accommodated for server rooms, information specifying each story of a building locating each server room, or the like.

The controller 13 stores coordinate information [X,Y] of the server rack 1, which is input by the rack coordinate input device 11 and then displays it on the rack coordinate display 12 (step S12). Additionally, the controller 13 periodically sends coordinate information [X,Y,Z] (which will be referred to as secondary coordinate information in comparison with two-dimensional coordinate information as necessary), which includes a number Z assigned to each tier of the server rack 1 in addition to the coordinate information [X,Y] (step S13).

For instance, the radio communication module 14, mounted on a first tier (or the lowest tier) of the server rack 1 located at coordinates [1,2] in a server room, sends coordinate information [1,2,1]. Similarly, the radio communication module 14, mounted on a second tier of the server rack 1 located at coordinates [1,2] in a server room, sends coordinate information [1,2,2], while the radio communication module 14, mounted on a third tier of the server rack 1, sends coordinate information [1,2,3]. In this connection, the number Z specifying each tier of the server rack 1 has been stored in a memory of the controller 13 of the server rack 1 at a manufacturer.

FIG. 3 is a flowchart illustrating a procedure of acquiring coordinate information by the server 3. The radio communication module 32 of the server 3 is normally placed in a reception standby mode during operation of the server 3 in progress (step S21). Then, the server 3 makes a decision as to whether or not the radio communication module 32 receives secondary coordinate information from the radio communication module 14 attached to the prescribed tier of the server rack 1 (step S22). Upon detecting a decision of “YES” indicating that the radio communication module 32 has received secondary coordinate information, the BMC 31 retrieves the secondary coordinate information from the radio communication module 32 and stores it as a representation of its own coordinates (step S23). Upon detecting a decision of “NO” indicating that the radio communication module 32 has not received secondary coordinate information, the flow returns to step S22 so that the radio communication module 32 is waiting for reception of secondary coordinate information from the radio communication module 14. The mutual communication of secondary coordinate information conducted between the radio communication modules 14 and 32 is automatically carried out when the server 3 is mounted on the prescribed tier of the server rack 1.

The administrative station 5 periodically collects the secondary coordinate information stored in the BMCs 31 of the servers 3 by use of the centralized management software 51 via the management network 4, thus performing centralized management on positional information tied with IP addresses.

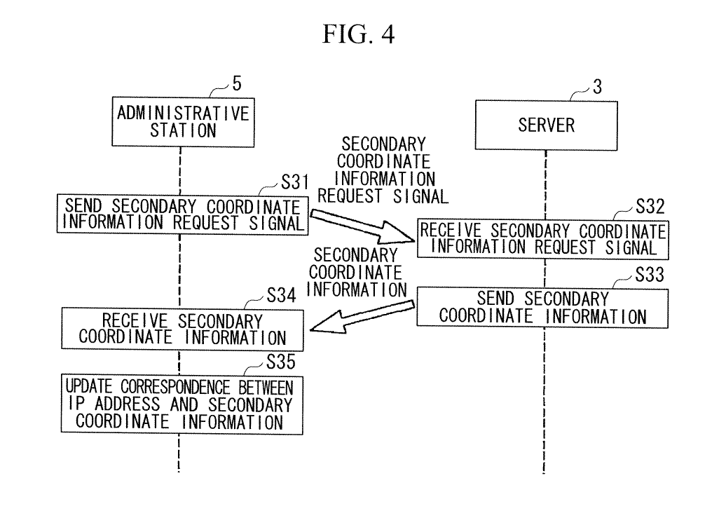

FIG. 4 is a sequence diagram illustrating a procedure for carrying out mutual communication on secondary coordinate information between the administrative station 5 and the servers 3. First, the administrative station 5 sends a request signal, using a specific IP address, which requests transmission of secondary coordinate information from a server 3 (step S31). Subsequently, the server 3 designated by the specific IP address receives the request signal from the administrative station 5 (step S32). The server 3 receiving the request signal sends back its secondary coordinate information to the administrative station 5 (step S33). Then, the administrative station 5 receives the secondary coordinate information from the server 3 (step S34). The administrative station 5 adopting the centralized management software 51 stores the positional information, based on the received secondary coordinate information, in connection with the IP address of the server 3 (step S35). That is, the administrative station 5 may register new positional information or update existing positional information. Herein, the “positional information” indicates the position of the server 3 mounted on the prescribed tier of the server rack 1, i.e. a combination of the setup position of the server rack 1 and the mounted position of the server 3 inside the server rack 1. The positional information may correspond to the secondary coordinate information, or the positional information may be created by converting the secondary coordinate information into predetermined characters and/or numbers.

A series of steps S31 to S35 is periodically repeated with respect to each of the servers 3.

Since the rack-mounted position management system of the present embodiment is designed to efficiently manage servers by use of physical positions of servers, it is possible to automatically recognize mounted positions of servers by simply installing servers into server racks. As shown in FIG. 1, the server rack 1 is equipped with the controller 13 (which is configured of a microcomputer) and the radio communication modules 14, thus storing and transmitting the setup position (or positional information such as coordinate information) of the server rack 1 in a server room. An installer who handles installation of the server rack 1 in a server room needs to set positional information to the server rack 1 by operating the rack coordinate input device 11 and the rack coordinate display 12. Additionally, each server 3 implements its radio communication module 32 so as to retrieve the coordinate information from the server rack 1. When the server rack 1 recognizes that the server 3 is installed therein, the server rack 1 adopting the radio communication module 14 sends the positional information to the server 3. Herein, the server rack 1 is able to recognize installation of the server 3 therein by way of a periodical communication of the radio communication module 14. Thus, the server 3 is able to retrieve its positional information.

The present embodiment is able to demonstrate the following effects without using an additional communication device or a dedicated communication line used for conducting communication between the server rack 1 and the administrative station 5.

### (1) First Effect

It is possible to efficiently manage numerous servers by use of positional information of servers. It is not realistic that data centers using numerous servers adopt the conventional method for detecting positions of servers by use of positional information which is manually registered per each server in advance. In contrast, the present embodiment provides a unique rack-mounted position management system ensuring automatic recognition of positional information of servers. The present embodiment enables large-scale data centers, installing a very large number of servers, to precisely manage servers by use of positional information of servers which can be promptly retrieved from memory. It is expected to provide an outstanding server management effect based on positional information of servers, particularly in large-scale data centers. As the number of servers installed in data centers becomes larger, it becomes more difficult to specify servers subjected to manual operation such as maintenance without using precise positional information of servers. Since the present embodiment can provide precise positional information of servers, it is possible to easily specify servers subjected to manual operation irrespective of the number of servers.

### (2) Second Effect

It is possible to alleviate loads on maintenance workers since the present embodiment is designed to automatically recognize positions of servers. In the rack-mounted position management system of the present embodiment, the servers 3 installed in the server rack 1 are able to recognize their positions and send positional information to the administrative station 5; hence, maintenance workers can easily retrieve the positional information of the servers 3 without manually managing the servers 3 installed in the server rack 1 at its setup position. This significantly reduces loads on maintenance workers. Additionally, the present embodiment does not require maintenance workers to collect positional information of the servers 3; hence, an installer is able to promptly install the servers 3 into the server rack 1.

### (3) Third Effect

The rack-mounted position management system of the present embodiment allows the servers 3 to autonomically recognize their positions by themselves; hence, the server management system is allowed to simply retrieve the positional information from the servers 3 according to ordinal procedures. This allows the administrative station 5 to easily retrieve positional information and conditional information according to the existing communication protocol for retrieving operational information of the servers, such as SNMP (Simple Network Management Protocol). In other words, the present embodiment does not require the administrative station 5 to provide a complex structure for retrieving positional information from the servers 3.

Additionally, the positional information of the servers 3 can be displayed using a Web-based control panel incorporated in each server, so that a general-use personal computer, which is not installed with specific management software, can be adopted as the administrative station 5 to manage the servers 3 with reference to their positional information.

Moreover, the present embodiment allows the servers 3 to autonomically accumulate their positional information by themselves; hence, the accumulated positional information can be utilized in terms of traceability. When the server 3 stores its history of positional information, for example, the server 3 can easily determine its original position. Even when an asset manager who conducts fixed asset management finds out a deficiency of servers, for example, the present embodiment allows the asset manager to estimate the positions of missing servers based on positional information. That is, the positional information of servers can be used as the reference information used for searching missing servers.

The present embodiment can be modified in various ways. For instance, a modified example can be produced using the basic configuration of the present embodiment but adopting a different type of radio communication device. Instead of NFC, IrDA, and RFID, it is possible to employ various types of radio communication such as ZigBee and low-power radio communication. It is possible to employ a high frequency contact communication method or a wired communication method, although this needs laborious setup work for connecting cables to servers installed in server racks.

It is possible to create programs, recordable on computer-readable recording media, implementing a part of or the entirety of the functions of the controller 13, the BMC 31, and the centralized management software 51. Those programs are loaded into a computer system to implement the functionality of the rack-mounted position management system. Herein, the “computer system” may embrace the operating system (OS) and the hardware such as peripheral devices. The computer system using the WWW system may embrace a homepage provider environment (or a homepage display environment).

The “computer-readable recording media” may encompass flexible disks, magneto-optic disks, ROM, portable media such as CD-ROM, and other storage devices such as hard-disk units installed in computers. Additionally, the computer-readable recording media may encompass communication measures, which are able to dynamically retain programs for a short period of time, such as communication lines (e.g. telephone lines) and networks (e.g. the Internet) used for transmitting programs, and storage measures, which are able to retain programs for a certain period of time, such as internal volatile memory of computers acting as servers or clients. The programs may be created to implement a part of the functionality of the rack-mounted position management system, or the programs may be created as differential programs which can be combined with preinstalled programs of computers.

Lastly, the present invention is not necessarily limited to the aforementioned embodiments and its variations; hence, the present invention may embrace other modifications and design choices that fall within the scope of the invention as defined in the appended claims.

What is claimed is:

1. A rack-mounted position management system comprising:
a rack equipped with a plurality of transmitters for transmitting positional information in connection with a plurality of mounted positions;
a plurality of electronic devices mounted on the plurality of mounted positions inside the rack, wherein the plurality of electronic devices is equipped with a plurality of receivers, which are positioned opposite to the plurality of transmitters, and further equipped with a plurality of communication devices connectible to a network; and
an administrative station which manages the mounted positions of the electronic devices inside the rack and which is equipped with a communication device connectible to the network,
wherein upon receiving a request signal from the administrative station, the communication device of the electronic device sends the positional information, which is received by the receiver of the electronic device, to the administrative station, so that the administrative station determines the mounted position of the electronic device.

2. The rack-mounted position management system according to claim 1, wherein the positional information includes coordinate information representing a setup position of the rack and secondary coordinate information representing each of the mounted positions for mounting the electronic devices inside the rack.

3. A The rack-mounted position management system according to claim 1, wherein the positional information includes coordinate information representing a setup position of the rack and secondary coordinate information representing each of the mounted positions for mounting the electronic devices inside the rack, and
wherein the rack includes an input device that inputs the coordinate information,
a display that displays the coordinate information, and
a controller that combines the secondary coordinate information with the coordinate information so as to produce the positional information, so that the controller controls the transmitter to send the positional information.

4. A rack comprising:
a plurality of mounted positions for mounting a plurality of electronic devices; and
a plurality of transmitters for transmitting positional information in connection with the plurality of mounted positions.

5. The rack according to claim 4, wherein the positional information includes coordinate information representing a setup position of the rack and secondary coordinate information representing each of the mounted positions for mounting the electronic devices.

6. The rack according to claim 5 further comprising:
an input device that inputs the coordinate information,
a display that displays the coordinate information, and
a controller that combines the secondary coordinate information with the coordinate information so as to produce the positional information, so that the controller controls the transmitter to send the positional information.

7. An electronic device comprising:
a receiver that receives positional information inside a rack; and
a communication device that sends the positional information over a network.

8. The electronic device according to claim 7, wherein the positional information includes coordinate information representing a setup position of the rack and secondary coordinate information representing a mounted position of the electronic device inside the rack.

9. A rack-mounted position management method, adapted to a management system including a rack equipped with a plurality of transmitters for transmitting positional information in connection with a plurality of mounted positions, a plurality of electronic devices mounted on the plurality of mounted positions inside the rack, and an administrative station,
said rack-mounted position management method comprising:
receiving, by the electronic device, the positional information transmitted by the transmitter of the rack;
upon receiving a request signal from the administrative station, sending the positional information from the electronic device to the administrative station; and
determining, by the administrative station, the mounted position of the electronic device inside the rack.

10. The rack-mounted position management method according to claim 9, wherein the positional information includes coordinate information representing a setup position of the rack and secondary coordinate information representing each of the mounted positions for mounting the electronic devices inside the rack.
